(19) United States
(12) Patent Application Publication
(10) Pub. No.: US 2009/0024584 A1
(43) Pub. Date: Jan. 22, 2009

(54) RADIO FREQUENCY IDENTIFICATION (RFID) NETWORK SYSTEM AND METHOD

(75) Inventors: Sanjeev Dharap, Palo Alto, CA (US); Anurag Mendhekar, Los Altos, CA (US); Vijay Pawar, Foothill Ranch, CA (US)

Correspondence Address: DLA PIPER US LLP, 2000 UNIVERSITY AVENUE, E. PALO ALTO, CA, 94303-2248, US

(73) Assignee: Blue Vector Systems, Palo Alto, CA (US)

(21) Appl. No.: 11/869,061

(22) Filed: Oct. 9, 2007

Related U.S. Application Data
(63) Continuation-in-part of application No. 11/056,561, filed on Feb. 10, 2005, now Pat. No. 7,423,527.
(60) Provisional application No. 60/544,713, filed on Feb. 13, 2004.

(51) Int. Cl. G06F 17/30

(52) U.S. Cl. 707/3; 707/E17.008

(57) ABSTRACT

A real-time query processing system to locate and retrieve object data in a RFID network is presented. The object data can be located in any data stored on the network or may be data that is generated in response to the user request. The system is operated by a user-friendly web-based GUI that allows remote access by out-of-network computer systems. The real-time query processing system provides comprehensive and flexible searching of the RFID network using a simple interface that can be accessed from anywhere in the world. It enables an immediate and tailored response to supply chain and business management questions as they arise, and greatly facilitates management of the entire supply chain and the RFID network.

### RELATED APPLICATION/PRIORITY CLAIM

This is application is a continuation-in-part and claims the benefit under 35 USC 120 to U.S. patent application Ser. No. 11/056,561, filed on Feb. 10, 2005 which in turns claims the benefit of and claims priority under 35 USC 119(e) to U.S. Provisional Application Ser. No. 60/544,713, filed on Feb. 13, 2004, both of which are incorporated herein by reference.

### FIELD OF THE INVENTION

The invention relates generally to a computer-implemented system and method for managing radio frequency identification (“RFID”) networks and in particular to a system and method for deploying and managing RFID networks and processing and managing the data generated by RFID tags and other devices/sensors.

### BACKGROUND OF THE INVENTION

With the increasing proliferation of cost-efficient and powerful computing and communications capabilities comes the ability to deploy sensors and link them to a network. The benefits of this link is obvious in some areas, for example in enterprises like supply chain management (SCM). A supply chain includes manufacturing centers, transportation fleets, warehouses/distribution centers and retail/wholesale outlets. Information about goods in the retail/wholesale outlets, for example, can be obtained from a remote computer that is connected to the sensors that track the goods.

Current object tracking solutions are based on bar codes and the use of bar code readers. A bar code system requires bar codes to be in good condition and must be in the line-of-sight of the readers. The wear and tear on labels and the difficulty of guaranteeing that the label is presented appropriately to the reader are major hindrances to increased automation as they often require human intervention. Since human intervention is required during normal operation, the workers could detect and remedy incorrect or faulty operation of the devices/system. RFID technology offers a more reliable solution than bar codes and lends itself to automatic operation (i.e., with reduced human involvement) because the radio frequency technology is less sensitive to factors like the condition and the position of the sensor devices. Further, RFID can monitor devices at a higher rate than bar codes, thereby allowing an increase in the throughput of goods and services when the existing infrastructure is coupled with RFID. Since no operator is needed on site for an RFID-based operation, the operation is usually monitored from a remote terminal that is linked to the sensor device, through a data network.

A problem with the currently available RFID data network system is that information only travels in one direction, from the RFID sensors to the monitoring terminal. Thus, although the user can see that something problematic is happening, there is no method in the system for addressing the problem real-time. For example, a user may see that a package is traveling on a wrong route based on the tracking done by the RFID sensors. However, there is not much the user can do to correct the route when he sees the problem. By the time he can re-route the package, for example through a series of phone calls that eventually reach the delivery truck driver, the package may have already arrived at the wrong destination.

Although a post-mortem analysis of what happened might provide useful information for future implementation, the data would be much more useful if something could be done about a problematic event more promptly. An organized method that allows quick perception and prompt response to a complex situation is desired. Since computing power and sensor devices have become cost-effective and readily available, large numbers of sensors can be deployed to provide superior resolution. By employing the appropriate numbers of sensors and computers/networks, an infrastructure that can 1) support a large number of sensors of diverse capabilities; 2) provide easy configuration and rapid deployment and networking of the sensors; and 3) provide a simple one-stop solution to configuring and managing the sensors.

The software standards set by standards bodies, such as the Auto-ID center defined Savant based architecture, are designed to handle EPCGlobal data and form the basis of most REID solutions today. However, these solutions are unable to handle generic event data and are limited by their adherence to a narrow standard. The inflexible adherence to the standard restricts their ability to scale up to larger, more diverse implementations made up of heterogeneous sensor devices.

Since the value and the utility of the information from the sensor often reside in the relationships between the data, a solution that can deploy, manage and process data in order to extract information, and in some cases even act on the data to facilitate the business activities of the enterprise, is needed. Such a system that can interface and interact with existing systems is desired. The system is preferably agile and scalable so that it can evolve along with the changing needs of the enterprise.

### BRIEF DESCRIPTION OF THE DRAWINGS

FIG. 1 is a diagram illustrating an example of an RFID system that may include a query/search system;

FIG. 2 is a diagram illustrating that the network management computers of FIG. 1 may be connected with one another other to form a larger network;

FIG. 3 is a diagram illustrating the aspect oriented program that is part of the RFID system shown in FIG. 1;

FIG. 4 is a flow diagram depicting the compilation and code generation process performed by the AOP engine in the network management computer of FIG. 1;

FIG. 5 is a flow diagram depicting a method for searching and real-time query processing implemented in the RFID system shown in FIG. 1; and

FIGS. 6-8 illustrate an example of the user interface of the searching system described with reference to FIG. 5.

### DETAILED DESCRIPTION OF THE EMBODIMENTS

The invention is particularly applicable to the searching and real-time query processing of the data from an RFID network system that may be used for monitoring and tracking of goods in a supply chain or a distribution network, starting at the manufacturer and proceeding all the way to the end customer. The search system may also be used in applications where the input stimuli are not necessarily the output of a sensor probing the physical environment. For example, it can be applied to monitoring and managing stock market operations, where instead of RFID events there are stock transactions. In the stock market context, the system can monitor whether regulatory requirements are being met. In another example, the invention may be used to track travelers entering and leaving the country by scanning their documents and generating events and exceptions in accordance with whether they are adhering to travel-related laws.

A “computer,” as used herein, is intended to mean any electronic unit having a processor, a memory, and one or more portals for connecting to other devices. A “sensor” is intended to mean any device that generates a signal when a predefined condition is detected or read, and includes but is not limited to an RFID-tag sensor/reader.

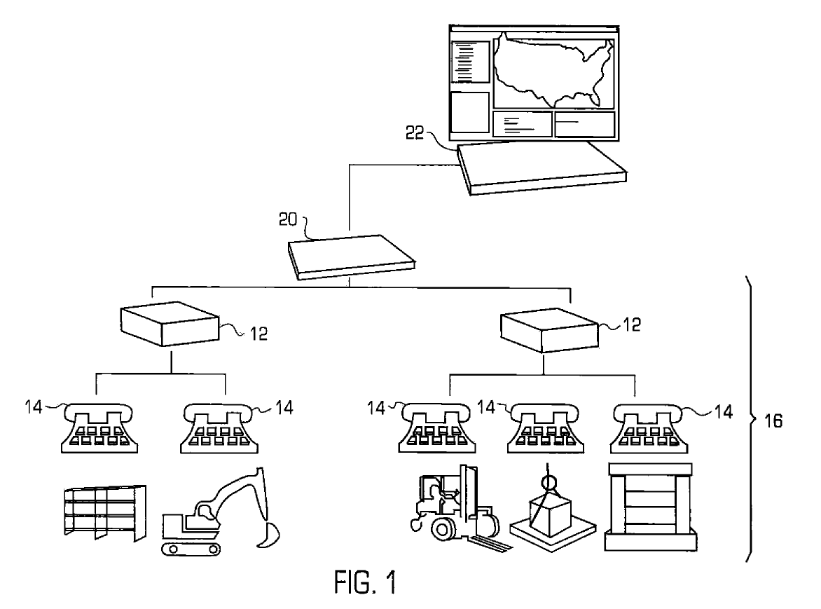

Prior to describing the search/real-time query processing system and method, an example of a management system that uses RFID sensors and an RFID system that may incorporate the search/real-time query processing system and method is described in more detail with reference to FIGS. 1-4. The system is configured by a web-based management system that is a Graphical User Interface to a specification system based upon an Aspect-Oriented Processing Engine designed to support large-scale distributed systems. The engine consists of a specialized compile-time source-code transformation system that takes in multiple descriptions of various aspects about the system and merges these descriptions into code-images that run individually on each of the participating computers in the distributed system. These aspects include: network hierarchy (which computer is connected to what), network characteristics (what kinds of links connect the computers), physical layout (how the computers are arranged in the context of a physical deployment), functionality (what the system actually needs to do), system health (information about the state of the system), data quality (what to do to make sure that the data coming out of the system is error-free). The Aspect-oriented processing engine allows programmers to specify each of these aspects independently, allowing very rapid configuration and customization of the underlying distributed computing system. Further, the functionality aspect itself is broken up into programmer selectable sub-aspects (called behaviors) which can be combined to create complex behaviors or schema. A behavior can be used as an abstract building block of the user application. Behaviors are configurable and have parameters attached to then that then make them very flexible and applicable to a vast range of applications.

A business process or a sub-section thereof can be represented in the abstract or formally as a schema, constructed by the user using appropriate behaviors. The schema must be parsed and transformed into a logical overlay; this only requires knowledge of the building blocks and the processing dependencies and constraints. This logical overlay has to be mapped onto the network of sensors and processing nodes (physical overlay), which would require knowledge of the organization of the sensors, the routers and the network management computer nodes and the zone hierarchy mapped onto them. The drag and drop GUI allows for a quick setup and efficient scaling up of the system. With the aspect oriented programming approach, once the specifications are provided in terms of the various system aspects, the aspect oriented engine then merges the requirements to create the solution. The aspect oriented server can then distribute the code images to relevant (only for those for whom the code images have changed) components of the network. This results in a self-configuring and self-managing system once the user has specified their requirements in terms of the aspects. The system can also be easily modified or added to as needed.

One of the advantages of the RFID system described herein is that it allows bidirectional communication between the monitoring terminal and the sensor devices. Like in the conventional systems, sensor devices send data to the monitoring stations. In addition, the system of the invention allows users to send configuration instructions to the sensor devices to reconfigure the devices as they wish. In more detail, the computers in the network connects to and acquire data from the sensor devices, convert the data/events to business information in accordance with prescribed workflows/schemas reliably, and route them appropriately. Additionally, the system allows the sensor devices to be configured, monitored and managed from a remote location.

The system has high reliability and robust operation with the ability to recover from partial/local crashes or disruptions in the network. Given that needs and requirements evolve over time, the system provides easy re-configuration of a deployed system and modifications in its workflow/schema in support of process evolution. The system also allows a user to instrument and gather data on the performance of the system so that changes and improvements in the system can be quantified. The instrumentation and data gathering capabilities of the system are also applicable in troubleshooting and debugging.

Another advantage of the system is that it is usable with a heterogeneous mixture of sensor devices unlike the currently available RFID-tag network systems. The system may include connectivity software that is capable of connecting to legacy systems and mixed equipment environments. This flexibility is especially useful when using the invention with an RFID system because RFID systems are generally applicable to a wide range of applications such as financial transaction, widgets on a production line, or regulatory requirements. The main difference between the RFID systems in these different applications is in the characteristics and types of sensor devices in the RFID system including the type of data being gathered.

The system also provides monitoring, device driver/control system diagnostics, alerts and notifications. Further, the system provides remote/on-line maintenance, upgrades, extensions, reconfiguring and/or redeployment of devices in the system. The system has self-healing capabilities such as the ability to (re)download the proper code images after a crash, and redundant mechanisms for backup. The system also has data monitoring and management capabilities that permit the system to perform data aggregation, synchronization and integration functions, real-time event monitoring, multi-protocol, format negotiations, and automated decision-making support tools. The system also has data storage, migration and resolution management tools, and application development environment/tools that allow a user to create an application. Thus, the system may include application and task authoring tools and a rich library of building blocks. The system also has device/application/system performance monitoring tools.

The invention provides a system and method for remotely monitoring and/or tracking objects and events. Unlike the currently existing solutions, the invention comprehensively addresses the requirements of rapid, large deployments, central management of resources, rich application development capabilities, streamlined operations management and flexible interfacing with legacy and partner applications. Current solutions focus on performing tasks such as interfacing with RFID readers, performing filtering operations on data, and basic management of readers but lack the ability to rapidly configure and deploy a network or provide ongoing real-time monitoring of objects.

Generally, the invention(s) presented herein allows the design of solutions where data from a variety of sensors can be collated to generate information for business processes in a seamless and uniform manner without restriction on the scale or type of operation.

System and Network Architecture

FIG. 1 is a diagram illustrating an RFID system 10 in accordance with the invention. The system includes one or more RFID routers 12 that interface with one or more sensors 14. Some of the sensors 14 are coupled to a Network Management Computer 20, which controls the communication between a user interface 22 and the RFID routers 12, and ultimately between the user interface 22 and the sensors 14. The groups of RFID routers 12 that are controlled by a single Network Management Computer 20 form a domain 16. The RFID reader/sensors 14 that are connected to one RFID router 12 can have varying capabilities and uses. Thus, unlike the currently available systems, the RFID router 12 can be connected to a heterogeneous mix of sensors 14 at the same time as long as the sensors 14 are capable of communicating digitally. Besides RFID sensors, the sensors 14 may be GPS devices, temperature sensors, pressure sensors, etc.

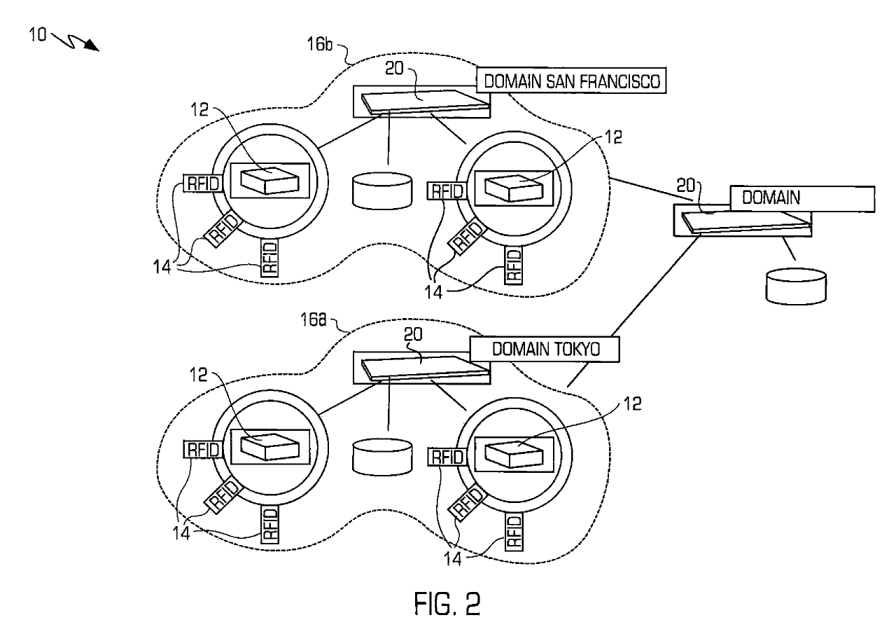

FIG. 2 illustrates that network management computers 20 may be connected with one another other to form a larger (e.g., worldwide) domain that includes all of the individual domains 16. The example shown in FIG. 1 includes a Tokyo domain 16a and a San Francisco domain 16b that are connected together to form a worldwide domain. The connections between the sensors 14 and the RFID routers 12, between the RFID routers 12 and the network management computers 20, and among different network management computers 20 need not be direct or wired connections. For example, these connections can be over the Internet. The communications between the devices mentioned above takes place by using standard, well-known internet protocols. The links between the various devices and application shown in FIG. 2 can be any type of communications link, such as wired or wireless connections or any combination of the two.

FIG. 2 illustrates that the network management computers 20 may be arranged in layers, or “zones” that are each controlled by a set of network management computers 20. The embodiment of FIG. 1 is a single-layered configuration whereby one network management computer 20 controls all the sensors 14. In contrast, in the multi-layered embodiment of FIG. 2, each domain 16a, 16b is controlled by a first layer of network management computer 20, and both of the domains 16a, 16b are controlled by a second layer of network management computer 20. Formation of zones makes it easy to control the sensors 14 because specific aspects and behaviors can be associated with particular zones. For example, in the embodiment of FIG. 2, a certain set of aspects and behaviors that are intended for the sensors 14 in Tokyo can be directed specifically to the network management computer 20 that controls the Tokyo domain 16a. The San Francisco domain 16b will remain free to be associated with its own set of aspects and behaviors.

One or more RFID routers 12 may form a domain 16 wherein the RFID routers 12 in the domain are connected to a network management computer 20. Each RFID router 12 is used to interface with, communicate and modify the configurations of sensors 14 that are connected to it. The RFID router 12 can issue commands/requests to the reader devices and the readers/devices then respond accordingly and/or the devices/sensors may asynchronously (independent of a specific command-response sequence and determined only by the configuration) communicate changes in its environment to the RFID router. In yet more detail, the RFID router 12 is a network element that can configure readers/sensor devices, monitor them, process data received from them and work in concert with the network management computer 20 to perform system operations. The RFID routers 12 come with a rich set of interconnections allowing it to interface with sensors 14 over a wide range of interconnections including but not restricted to Serial interfaces, Ethernet, and wireless. Likewise, the RFID routers 12 can communicate with the network management computer 20 using wired or wireless-interconnect.

The network management application 20 is the device through which the system is deployed and customized, and applications developed. The network management computers 20 also participate in the execution of the application and system functions. The network management computers 20 are capable of web-based management and operations using a drag-and-drop user interface for RFID configuration. It provides authentication for multi-user support. The configuration/customization features provide customizable data quality management and supports creation of new process and integration of existing business processes.

In accordance with the invention, the network/system may be hierarchically partitioned into one or more zones. A zone is an aggregation unit that can include one or more devices and can have configuration parameters, conditions/operations and behaviors attached to them. The zones are used to logically partition the RFID network for purposes of structured data processing and management. In accordance with the invention, the zones are hierarchically composed, i.e., a zone can be made up of other zones (sub-zones). The sub-zones cannot be split among zones. In a preferred embodiment, a zone can have only one parent zone, except when it is the root zone then it has no parent. In a preferred embodiment, there is no limit on the number of children a zone can have. In accordance with the invention, the zones (along with the devices and operations) can be replicated by copying.

Workflow

The system in accordance with the invention advantageously includes a mechanism to represent a process to be performed or modeled using the system. This modeling, representation and specification are termed the schema or workflow which can be hierarchically composed. The schema is not restricted to user business processes and this is specified in terms of the parameters of the different aspects. A workflow will, in general, be a specific sequence of operations which may include one or more of the following: the detection of events and monitoring of conditions, accessing data typically by querying, performing specific tasks, producing information in specified formats and some form of notification. The sequencing of the operations or the dependency of the operations can be time constrained.

A workflow/schema is composed of a number of smaller or sub-workflows/sub-schemas. Most are generic operations but often they are special processes or flows defined by standards, industry specific regulations, etc. A number of such building blocks are encapsulated and provided for rapid mapping of the user's business process into a workflow/schema. Such building blocks are an encapsulation of a sequence of actions to be taken when preset conditions are fulfilled. This encapsulation is available as a building block to be used in the design of the overall solution. It can be represented as a collection of different aspect specifications, which is herein referred to as a Behavior. A Behavior addresses very specific tasks that a collection of aspects might be able to accomplish. A Behavior is not limited to operate on data/events produced by the readers/sensors. A Behavior can take secondary events as inputs as well as external or user input. Thus, a Behavior may be used to configure the system or parts of it. In general, a programmer can annotate the Physical Layout with Behaviors as a convenient method to accomplish frequently needed tasks. For example, a counter Behavior is simply a counter. The stimulus for the Behavior counter can be specified as a particular event (perhaps an exception event). This association can be defined through the web interface as an annotation of the Physical Layout. During operation, each time the exception takes place the counter increments. By querying the counter periodically, a log can be maintained. The Behaviors can be combined and associated in a LEGO-like fashion to construct more complicated processes.

An operation is usually triggered by an event. The primary sources of events are the readers/sensors 14. The responses from sensors 14 that are either based on a command issued to it or due to a change in the environment it is monitoring are primary events. When the sensors 14 detect changes in their environment and generate an event, the event is “intrinsic.” Every intrinsic event has a name and is associated with a zone. A sequence or combination of events creates a secondary event. The parameters associated with a secondary event pertain either to the Partitioning aspect (system-defined) or to the Functionality aspect (user-defined). The two types of aspects are described below in more detail.

The appliances may be configured to monitor events or pattern of events (through the web interface) and determine whether certain conditions are fulfilled. The time ordering of events and constraints on the interval of time between events may be specified in a condition. The conditions are attached to a particular one or more zones. On generation of events in a zone, the conditions are examined by the appliances configured for that zone to determine if any action is triggered. A condition in one zone can create an event for another zone. Once a condition is satisfied, one or more operations can follow.

One of the operations may require data or state lookup for completion. This lookup process is accomplished by issuing a query to a database or other storage. The response to the query is then utilized in the operation. The query may address information in the system or third party information. Once the requisite sequence and pattern of events satisfies a condition and, if required, the subsequent information gathering completed, the system will initiate a user-specific task. On completion of a task or as part of a task, record keeping operations, status updates and state changes may be performed and notifications posted. This can take place in a number of ways.

In accordance with the invention, the system will attempt to automatically compose the selected Behaviors (those pick and mapped by the drag-and-drop GUI interface) and, in case of conflicts, the user is requested to arbitrate and select the correct one. This is accomplished by the use of a Behavior attribute called the signature. The signature of a Behavior includes its input/output characteristics as well as other operational parameters. In conjunction with rules for composition based on signatures the system automatically connects the Behaviors, when they are selected and dropped onto a location, with other Behaviors at that location.

For example, consider an application where a specific dock door at a warehouse is meant only for loading paper towels. The application-developer would then drag-and-drop a filter Behavior to that location and then set the range attributes of the Behavior to those corresponding to the codes for paper towels. The developer may set up an alarm notification when paper towels are received at the dock door. In addition, one can also specify the action in case a pallet containing items other than paper towels shows up at the dock door to keep track of how often a pallet shows up incorrectly at this dock door. The developer will then select a counter Behavior and drag and drop it to the same location as the filter behavior. On specifying the type of input it must handle (in this case an alarm event), the system will automatically assign the input of the counter to receive the alarm output of the filter Behavior. Working in this manner, a much more complex system of operations can be fashioned.

Behaviors are easy to add because they do not need knowledge of the compiler modules. A library system manages different behaviors and their parameterization in order to reuse them effectively. The intention is that end-users of the system can create their own behaviors and reuse them, while new aspects are added by specialized personnel who have the expertise to determine when a new aspect should be added and how.

The architecture of the AOP system allows runtime-updates of the system. When the behavior of the distributed system is modified, a new set of compiled code images is generated from the new aspect specification. If the generated code image for a network-element is different from the previous code image, the code distribution server asks the network-element to reload the code image by sending it a reload event. This request prompts the network element to reconnect to the code-distribution server, download the code, and restart itself. In certain cases, it is possible to restart the system by maintaining runtime-information that was generated by the previous code-image. In other cases, when the changes to a zone handler are significant, this may not be possible as it would require generating new information. Both these types of restarts are permissible in the system.

Through the use of aspects and behaviors, the invention allows the creation of a business process or schema that is implemented with varying degrees of automation. Merriam-Webster defines schema to mean, “a diagrammatic presentation; broadly: a structured framework or plan” or “a mental codification of experience that includes a particular organized way of perceiving cognitively and responding to a complex situation or set of stimuli.”

The system may provide standard data processing, filtering, and ONS/PML lookup operations. In particular, generic operations include such tasks as duplicate removals when multiple readers may overlap in reading a tag, in the standards based category would fall tasks such as performing ONS/PML lookups in an EPCGlobal compliant fashion. If the workflow/schema includes having to configure parts of the system, then the tasks that gather configuration information for the infrastructure could also be provided. Similarly, Behaviors that are required to interface and communicate with other Business Information systems (implementing functionalities required by Rosseta Net, XML, SOAP among others) are included as part of the library of the web-based configuration system.

In an exemplary chain operation, an object is observed and monitored by radio frequency as it moves through the supply chain in accordance with a business plan. The sequence is to observe the object as it leaves a first observation station (e.g., manufacturer), then observe it appear at a second observation station (a distribution center or possibly one of a set of retail stores), observe it be subjected to processing at the station and, on successful conclusion of the processing, observe it move on to a third station. The choice of stations depends on the planned route selected based on the starting point and the destination.

The time delay between the manufacturer's warehouse and the distribution center may be constrained, as in an SCM pallet that has to get to its destination by a certain time. For example, the pallet may contain certain chemicals or medications with an upcoming utility expiration date, stock transaction settlement, urgently needed documents, etc. The processing at the destination can be conditional based on when it arrives, as can be its next destination (e.g., a late arriving pallet may have to be re-routed). Additionally, logs may have to be updated.

In this example, then, the first event represents the departure of the object from the first station. This event in turn triggers a condition at each of the destinations that now watches for the object's appearance at the next station. The appearance of the object at the destination will, in turn, trigger a receipt process such as billing or checking its condition. Successful completion of this receipt process will then result in it being moved to its next destination (shelf or storage) in its path. In this manner, the object moves through a chain of stations until it reaches the final station. An exception or a deviation from its prescribed plan/route anywhere along the chain can result in generation of reports, which contain information/data necessary for a follow-up and notifications being sent often with remedial actions specified. The remedial action, if any, is provided via triggering a different set of tasks/agents and may include running diagnostics, re-deploying some resources and increasing the resolution of observations around the fail point (akin to zooming in) and also, perhaps, modifying the type of observations (along new axes when possible) to get a better look at the problem.

Aspect-Oriented Program

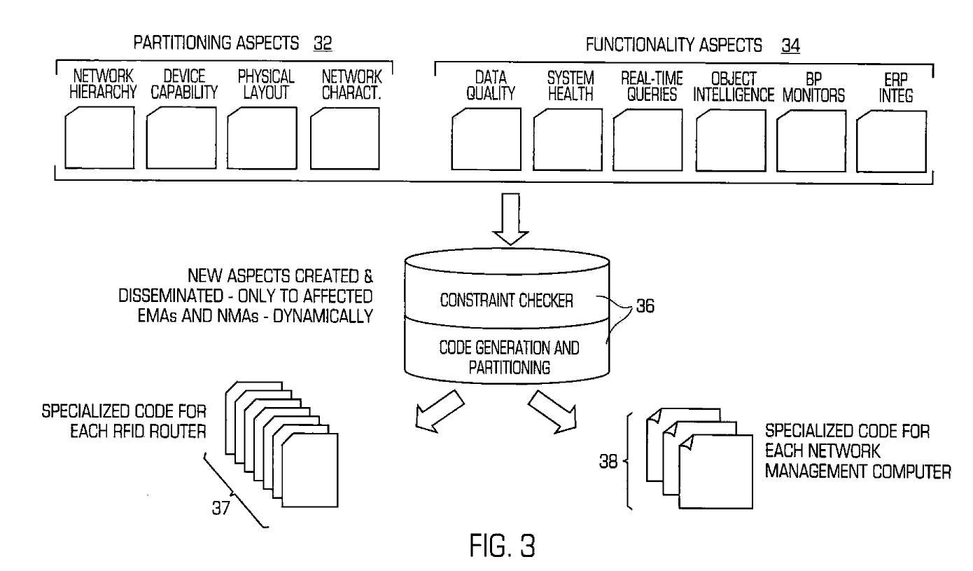

FIG. 3 is a diagram illustrating the aspect-oriented programming (AOP) 30 that may be used in the system 10 and more specifically in the network management computer 20. The AOP is responsible for the construction, execution, and coordination of a distributed system. The AOP server system consists of four key elements: AOP compilation, Distributed System Boot-up, On-going Operation, and Run-time updates. The AOP system is includes a weaver 36 that takes multiple aspect specifications and merges them into executable code for the system under development.

There are two types of Aspects: Partitioning Aspects 32 and Functionality Aspects 34. The Partitioning Aspects 32 pertains to network and hardware layout and limitations, and is not reconfigurable through the user interface 22. Partitioning Aspects include but are not limited to network hierarchy, device capability, physical layout, and network characteristic. For example, in a warehouse context, the types of sensors that are installed (device capability) and the way the sensors are wired (physical layout) are Partitioning Aspects that can only be changed by someone (e.g., an electrician) who goes to the warehouse, and cannot be changed by an input into the user interface.

When one or more sensors 14 are added to the system 10, the Partitioning aspects may have to be adjusted to incorporate the added sensors 14 unless there is already built-in support for newly added sensors 14. A sensor can also be replaced, e.g., with a different type of sensor. Thus, the sensors 14 can be plug-and-played fairly easily.

The Functionality Aspects 34, in contrast, are controlled through the user interface. Functionality Aspects 34 include but are not limited to data quality, system health, real-time queries, object intelligence, business process (BP) monitors, and enterprise resource planning system (ERP) interrogation. A weaver 36, upon receiving a user input, pulls the Partitioning Aspects that are relevant to the affected Functionality Aspects and generates appropriate code images. For example, if a user reconfigures the system to re-route a package from Route A to Route B, the weaver 36 identifies the sensors that are affected by this change by using the Partitioning Aspects, and generates code images that are directed to the affected sensors. The code images may, for example, direct certain sensors along Route A to send an alert if they detect this package (because that means the re-routing was unsuccessful), and direct certain sensors along Route B to look for the package. The code images are implemented by the RFID router 12 shown in FIG. 1.

Where there are multiple layers of NMAs as shown in the embodiment of FIG. 2, the top-level NMA generates code images not only for the network components downstream but also for itself. The portion of the code images that is generated for itself may be locally stored. In case of a crash, the code images may be retrieved from this local storage or regenerated. The top-level NMA forwards the code images that are not intended for itself to the appropriate network components.

An advantage of the AOP system is that it is user-friendly. In a conventional program, a user who wants to reconfigure the sensors would have to understand how the wires are connected before sending code images to the RFID routers 12. With the AOP system, however, a user can designate the configuration he wants, for example by moving icons on the user interface screen or typing in commands, without worrying about the constraints of the existing hard wiring. The hard wiring aspect is taken care of by the Partitioning aspect. The weaver 36 receives the user input, determines the best way to implement it by taking the Partitioning Aspects into account, and generates appropriate code images for the affected hardware components. This separation of the aspects makes the system 10 efficient and easy to use.

New aspects can be easily added to the system because of the simple way in which propagation and selection are specified. The actual semantics of how the annotation will modify compilation is slightly more involved and requires adding the requisite modules to be added to the compiler. The compiler itself is structured to accommodate these new annotations in order to support an evolution of the all the possible aspects within the system.

The input aspect specification to the AOP system 30 is based upon a hierarchical description of the physical process that is being automated. Based on the Functionality aspect specification received from the user and the Partitioning aspects 34, the weaver 36 generates code images and partitions. A code image 37 is generated for each RFID router, and a code image 38 is generated for each individual network management computer 20. Where there are multiple layers of network management computers, a code image 38 is generated for each network management computer in the “pyramid” of computers.

An aspect specification can be thought of as a collection of annotations around a core syntax tree. The semantics of the individual aspects determine how the annotations are propagated around the core syntax tree. The core syntax of the AOP specification is a tree-specification of the physical spaces in the process. These spaces are referred to as zones. The core syntax specifies a tree of zones. An embodiment of this syntax is as follows:

Zone ::=(Zone−name (Zone*))

Zone−Name :=“[text−character]+”

Each of the Aspect specifications are built around elements specified in this core syntax. For example, for the network hierarchy aspect, the hierarchy of networking elements is mapped onto this zone-tree (henceforth called the Physical Layout). What the aspect specification needs to yield, is a complete description of which zone is mapped to which network element (i.e., a networked computer). In one embodiment of this mapping, this is achieved by providing a sub-tree selection function and a propagation function. The sub-tree selection function selects a sub-tree from the Physical Layout and the propagation function propagates network-hierarchy information along this sub-tree. The network hierarchy aspect is then simply a syntactic specification of the selection and propagation functions. The semantics of this syntactic specification are provided by the compiler.

One embodiment of the syntax of sub-tree selection is 1 Zsexp :=(Zone−name*)(shallow−subtree of Zsexp)(deep−subtree of Zsexp)(with−property P Zsexp)

where P is a function in a programming language. In the system 10, this programming language is Scheme. Other methods of specification are possible, such as tree regular-expressions, etc. This sub-tree selection syntax is applicable across all the aspects, enabling a uniform way to deal with aspects. The compiler provides a few built-in propagation functions: Attach, Attach-with-inheritance and Attach-with-synthesis. The Attach function simply attaches the same annotation to each node. Attach-with-inheritance computes the annotation based on the annotation assigned to the parent of the node. Attach-with-synthesis computes the annotation based on the annotations assigned to the children.

The same scheme may be used to specify all aspects. An aspect specification, therefore, is a collection of sub-tree selection and propagation functions that propagate specific annotations.

The network-hierarchy aspect uses the Attach-with-synthesis function to assign network-element annotations. If all the children of a given zone are on the same network element, then that zone is assigned that network element. The propagation is iterated over-and-over until a fixed-point is reached. With this method of aspectual specification, new aspects can easily be added to the system.

Compilation

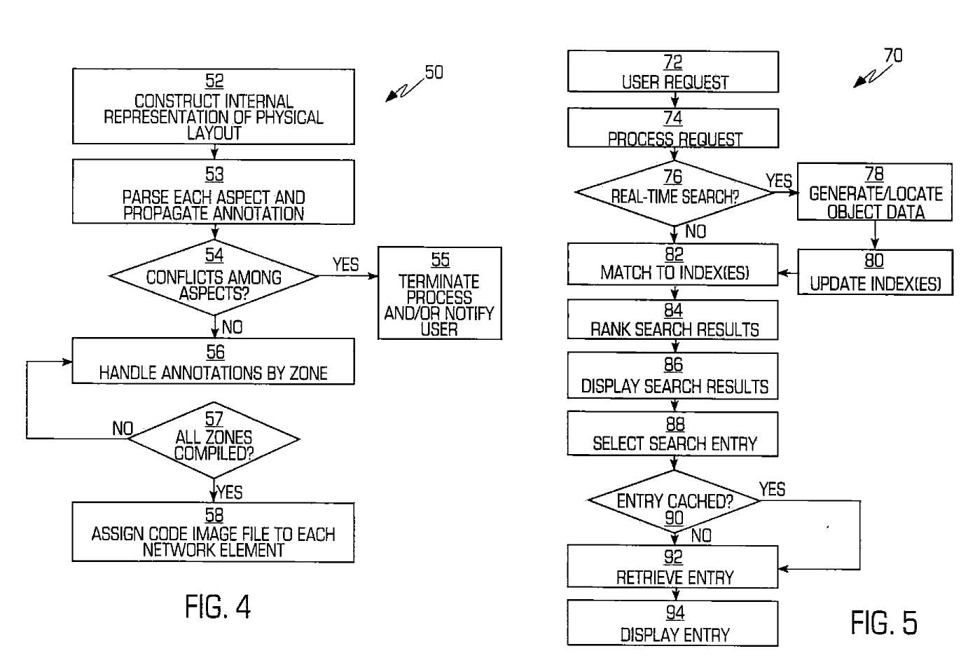

FIG. 4 is a flow diagram depicting the compilation and code generation process 50 performed by the AOP engine in the Network Management Computer. The AOP engine compiles the data by constructing an internal representation of the Physical Layout (step 52). Then, each of the Aspect specifications is parsed and the annotations are propagated (step 53). If there are any conflicts that get generated by different aspect specifications (step 54), these conflicts are reported and the compilation is terminated (step 55). Once all the annotations are propagated, each zone is compiled into a “zone-handler.”

Each zone handler is responsible for handling all the processing related to the relevant zone. This processing begins with managing RFID readers and other devices in the zone, going on to handling events that are generated by these devices and other processes that occur in the zone (such as timers, etc.). These events are handled according to the annotations that were placed on the zone by various aspects (step 56). For example, the system health aspect will cause the zone to record events coming from devices according to a system health criterion, but the Functionality Aspects will require the event to be treated as a decision making unit for overall semantics of the system.

Once the system has compiled all the zones (step 57), code is generated. Each network-element in the system is assigned a Code Image file (step 58). The Code Image file contains code for each zone that resides on that network-element. The Code Image file is generated as a source code, then compiled by traditional means to generate binaries that are distributed to each network-element during boot-up.

System Boot-up and Operation

The distributed system includes a “code distribution” module that is also a network element. When it boots up, it looks up and loads the code image that corresponds to it. Once it is up and running, other network elements can connect to the code distribution module and download their respective code-images. The code-distribution server can selectively ask other network elements to reload code-images if they have changed (due to network or system upgrades). The network elements have a discovery protocol for discovering the code distribution module. Since any newly added network element will be updated by reaching the code distribution module with the discovery protocol, new network elements can be added without pre-configuration.

The code distribution module does not have to be started before other network elements. If other network elements start running first, they will hunt for an available code distribution module until one gets started. Some network elements may be capable of caching the code images. The code distribution server will only send them a new image if it has been updated. In this way, the entire network boots up and configures itself to carry out the functionality that is expected from the fully annotated Physical Layout tree.

Once the system is up and running, the execution expected by each of the individual aspect specification occurs through the coordinated interoperation of the zone-handlers in each network element. For example, system health monitoring is done by heartbeats that are propagated along the network hierarchy. This system health behavior can be modified by changing the aspect specification to require new information to be computed and propagated.

Inter-zone operation is handled by exchanging events between zones. Each zone queues events that will be handled by the zone handler. Network elements can assign events to these queues through a network protocol. Due to the layout of the distributed system being known at compiling, each network element has information about what is being executed in the other zones, and it is possible to route events directly to a chosen network element to achieve the inter-zone operation. This mechanism is used, for example, to send system health information to its immediate parent in the network hierarchy, as required by the system health aspect.

When the changes to the system are drastic, the entire network is restarted and all network elements will download the new code images from the code distribution module.

User Interface

Referring back to FIG. 1, the system 10 includes a graphical user interface 22. A central computer (not shown) contains data and computer instructions/software modules associated with the RFID system 10. The system 10 may further include a web server connected to the central computer that allows the graphical user interface 22 to act as a web-based user interface. The RFID system 10 may be set up and configured (based on the elements shown in FIG. 1) through the web based graphical interface through which the user specifies the attributes for the different aspects of the system. For example, the user may set up and configure the physical components (readers, routers, network management computers) of the network according to their individual needs. The user may also specify a logical partitioning (into zones) of the network and establish a hierarchy as determined by their solution and map it on the physical infrastructure. Once the zones are established, the user may define actions and operations wherein the actions and operations may be defined, created and installed on a zone-by-zone basis. This is further facilitated by the provision of a set of predefined behaviors representing some of the common tasks expected in RFID systems and available through the web-based graphical interface, such as monitoring of shelves and dock-doors but not limited to them. In accordance with the invention, additional behaviors can be quickly developed.

Further, the operations and actions can also be specified using the web-based graphical interface 22. For example, the user may specify the processing of data, the creation of and assignment of conditions to be monitored, the conditions related to data or patterns of data, the conditions related to the operation of any of the devices in the system (health management), the chaining of conditions and events to form more complex sequence of operations and the composing them further such that the final solution can comprise of different dependent processing components which are distributed over the network.

This (web based) user interface 22 also allows the user to quickly enhance their network by adding new components and/or modifying existing ones. A number of additional functions such as automatic health management of the infrastructure, data health management, and information about network characteristics can also be centrally/globally specified. These additional functions and information result in a more robust and a more efficient system operation. The user can, through this interface, observe the operation of the system, probe different aspects of it, and modify operational parameters of individual components or modify parameters of zones or even make global changes.

At the outset, a user has a set of requirements or expectations in terms of performance. The RFID infrastructure can be used to monitor and observe whether they are being met. Unexpected or incorrect operation can be detected and flagged. Observations can be recorded through logging pre-specified information (raw, event statistics etc) and notifications can be enabled. The notifications can be configured to be one or more of logging, email alert, page alert, alarms or exceptions among others. Examples of such applications are, on time performance, looking for defined patterns/distributions (statistics), or regulatory processing. Notification can be the triggering of different levels of alarms when violations or anomalies are detected.

Once the ability to detect events of interest exists, the user may wish to enhance the system to speed up response to anomalous situations. In order to analyze the anomalous or exceptional behavior, additional information relevant to the resolution of the anomaly/exceptional behavior may be needed. This collating of events and contextual data is then made available to the resolving entity for speedier problem resolution. Hence the notification incorporates report generation by culling relevant data from the enterprise (which may be obtained by querying various databases, internal and/or external) and formatting it in support of resolution, possibly with recommendations/hints and forwarding it to the relevant decision makers (humans or software). Enabling the appropriate record keeping helps generate business intelligence at a high resolution.

Using the high-resolution business intelligence, the user can build a more responsive system by automating the more frequent cases based on the resolutions applied at the previous level. This way, the system can evolve in terms of the type of data logging and exception detection to using additional relevant information and finally to making decisions. Iteratively, in this fashion, the user automates away into the normal flow of the business process what were earlier exceptional or anomalous behaviors and hence minimizes human intervention as time goes by.

The goal can be viewed as that of maintaining a certain state by observing certain parameters and responding to changes in them. Other examples of automatically closing the loop include triggering response actions (automatically generating and issuing purchase orders when inventory levels drop below threshold).

This is accomplished by providing the user with the means to define metrics for performance evaluation of their systems and then using the same event processing infrastructure to keep track of performance data. For example, the inputs to the performance evaluation system are the exceptions representing failures in the business process flows. The user can define counter-behaviors and assign them to assertions in different parts of their workflow/schema. A periodic log of the state of the counters is kept to create a performance history. This history can be post-processed to isolate problems and develop refinements. A similar approach can be used to monitor the health and status of the infrastructure. A similar process can be applied to diagnostics and debugging.

An exemplary implementation of the user interface 22 will now be described. The exemplary web-based GUI consists of the System Status Dashboard and the Customization Interface. The System Status Dashboard is the first page that opens after a user logs in. In a preferred embodiment, the system status dashboard may have three panes including a network status pane, an inventory search pane and a query results pane. The Network Status pane has status information on the network elements, such as NMAs, Routers and Sensors. If any of these elements is down, it flashes a system alert. A click on the pane shows the network status table. The Inventory Search pane shows the current inventory status in a table format. The user can search for inventory by Name or by EPC tag, or do an SQL Query.

When the user clicks on a Customize RFID button on the System Status Dashboard page, a Customization Interface is opened in a new window. The Customization Interface is used to set up the RFID installation interactively. On the Customization Interface page there are 5 panes, which are described below:

The CONFIGURATION ICONS pane shows tabbed view of objects that can be manipulated to create the RFID installation. Icons for Objects (Distribution Center (DC), Dock door (DD), shelf), Behaviors (eg. Debug, Mature Data Set) and Devices (RFID Reader) are provided. These icons can be dragged and placed in the layout pane to create new instances of objects, behaviors and devices.

The ZONES pane shows the hierarchy of zone names starting from the root zone, which is the complete RFID Installation. The hierarchy is shown in a tree format. A single click on any zone name in this pane opens up the zone in the layout pane and a right click opens up a menu.

The LAYOUT pane shows the physical layout when a zone is opened. It has information about where each object is placed. Objects can be dragged and placed in the zone layout. Objects added to this zone show up as icons. Each icon can be double-clicked and opened out in the layout pane. A right click on the icon opens up a menu.

The PROPERTIES pane shows the name, behaviors and their parameters for the opened object.

The HELP pane shows context sensitive help.

The web-based GUI may also include a tool bar. The toolbar may have the following button: Clear, Undo, Refresh and Update. The clear button clears the physical layout of the opened object, the undo button permits the most recent clear or delete operation to be reverted. The update button updates the server with the current configuration and then it restarts the server and passes the new script to all the clients that are connected to it. The web-based GUI may also include a status bar that shows the names of icons, if the user places the mouse over them. Now, the aspect oriented server of the system will be described in more detail.

In accordance with the invention, to set up an exemplary system/network in accordance with the invention, a sequence of steps may be performed. In particular, objects from the Configuration Icons pane of the user interface can be dragged and dropped to the Layout pane. The objects may come with certain default behaviors. Next, a DC from the Objects tab is first dragged and placed in the main window. Many such DCs can be placed in different geographical locations nationwide. Each DC comes with a default NMA behavior, which associates it to a particular IP address and location. Then, DDs and shelves can be added to the DC. These objects similarly come with a default Router behavior. Next, readers can be added to the DDs and shelves. These readers automatically detect the router and the port to which they are connected. As the objects are added to the Layout pane, their names get added to the Zones pane and the entire hierarchy can be seen in this pane. Clicking any zone name in this pane, opens it in the Layout pane. Behaviors are added next and they show up as icons in the behavior panel. The behavior panel shows all the behaviors for the opened object. One behavior may depend on other behaviors. If a behavior has certain parameters, a window pops up waiting for the user input. For example, if a Mature Data Set Behavior is added to a DD, the user can enter the maturation delay. A right click on the icon opens a menu, which allows the user to edit parameters for that behavior. Once a DC is set up, it can very easily be managed. The right click menu on each object has copy, paste and delete features. The most powerful feature is the ability to replicate objects. For example, once a DC is set up, it can be copied and pasted at different locations. Thus, it is very easy to move from a pilot installation to a full-scale production.

Business processes tend to be complex and dynamic operations. Thus, it is important for it to be implemented in a system that can evolve with the changing needs. In accordance with the invention, the user can utilize the capabilities of RFID system 10 to progressively improve their insight into the business processes, which then can be applied to create improvements and increase the value that they can accrue from such a system. Now, the search/real-time query system and method, that may be used with the system described above in great detail, is described in more detail.

FIGS. 5-8 depict a search and real-time query processing system and method. In one embodiment, the query system and method is implemented in software as a plurality of lines of computer code that may be executed by the network management computer 20 shown in FIG. 1 for the RFID system shown in FIG. 1. The search/real-time query processing system and method can also be implemented in hardware or a combination or hardware and software and is not limited to the software implementation in combination with the RFID system shown in FIG. 1. In the RFID system shown in FIG. 1, the query function is usually started by selecting a Query option on the web-based GUI screen described below and a separate results pane may show the results of the query. The query option allows the user to query the system or user-selected parts of the system. Some queries are responded to immediately (e.g., report what is visible in zone X) while other queries are “persistent” (e.g., report the next time event Z happens). Queries can address the data or the state of the system. They may access process/workflow profiling data to assist with debugging.

The real -time query processing system may be used to locate and retrieve object data regarding a specific object or class of objects in response to a user request. This object data can be located in any data stored on the network, or can be data that is generated in response to the user request. The system may search the data stored on the network as well as generate and search real-time data. The system is operated by a user-friendly web-based GUI that can be remotely accessed by out-of-network computer systems. A user may use the web-based GUI to request object data for a specific object (e.g., location of widget Z) or may request object data about a class of objects (e.g., number of widgets currently in warehouse A). The real-time query processing system therefore provides comprehensive and flexible searching of the RFID network, using a simple interface that can be accessed from anywhere in the world. It enables an immediate and tailored response to SCM questions as they arise, and greatly facilitates management of the entire supply chain. In addition, the system is configurable to enable different levels of access.

FIG. 5 is a flow diagram depicting an example of a real time query processing method 70 implemented in the RFID system shown in FIG. 1. In this example, the method may be implemented by a plurality of line of computer code executed by the network management computer 20 shown in FIG. 1. In one embodiment, the network management computer 20 may have a query processing unit that performs real-time query processing that further includes a crawling unit that generates the index file described below and a retrieval unit that performs the query processing and returns the search results to the user. In step 72, a user requests object data using the web-based GUI of the system. The real-time query processing system processes the request in preparation for matching to an index (step 74). If the object data request requires the system to perform a real-time search to generate/locate object data (step 76), the system generates/locates the object data (step 78) and updates the index to reflect the new data (step 80). The real-time query processing system then matches the processed object data request to an index that includes the location of object data stored on the network (step 82), generating search results. The system ranks the search results (step 84) and displays them to the user (step 86). The user may select a search result entry (step 88). If the search result entry is not cached (step 90), the system retrieves the object data from its location on the network (step 92) and displays the entry and associated object data to the user (step 94). If the search result entry is cached, the system can display the entry and associated object data to the user directly.

The object data that can be searched using the real-time query processing system may be any data requested by a user, and can include data associated with an object that is monitored and tracked on the RFID network or data associated with an object that is part of the RFID network shown in FIG. 1. The object data requested by a user might include all or a portion of the total object data available for that object. For example, the object data requested by a user might be the physical location of the object. However, data such as route information, state information, date registered, etc., in the system for that object would all constitute object data.

The object data can be located in any data stored on the network, such as logged event data, record-keeping data, status update data, state change data, or notifications generated in accordance with a behavior or conditional operation. The data does not need to be exclusively related to the specified object, but can be data that is associated with another network component, operation, or object. Consider the following example. Logged event data may be event information from a specific domain, an RFID router, or device or sensor. Thus, the event information could be raw or processed data regarding delivery events to a certain retail outlet over a period of time. The data might contain information regarding a number of objects (e.g., goods delivered to the retail outlet during that time), and the object data requested by a user might be only one part of the logged information (e.g., only one entry corresponding to the day that the object was delivered). In this case, the logged event data would contain object data, although the logged event data would not be limited object data. It should be understood that although the event information might include object data, that object data might not be the data requested by a user (e.g., the user requested origination information for the object, and not destination information).

In addition, some stored data might consist entirely of data corresponding to a specific object. Record-keeping data, for instance, may include registration information for a single object (e.g., type of object, RFID tag information, date registered in the system, etc.). A certain event may have triggered a behavior or operation to generate an object-specific log; for example, the object may have initially been routed to the wrong destination, prompting the system to monitor the object until the error was corrected. In both cases, the data is entirely object data. It should be noted that data which is composed entirely object data might still not contain the type of object data requested by a user. If the user requested the physical location of an object, record-keeping data containing only the information described above would not be relevant. The real-time query processing system is also able to parse and match object data in accordance with a user request.

The object data also can be data that is associated with a particular network object or component, such as a sensor or other device, or may be data related to the state of the RFID network. Object data is not limited to goods or other objects which are being monitored and tracked by the system. The real-time query processing system may be used to locate and retrieve object data regarding almost any aspect of the RFID system. Thus, data stored on the network pertaining to a certain sensor, including logged event data, status data, notifications, etc., may constitute object data. Similarly, data corresponding to a particular network state (e.g., error reports in the Tokyo domain) may also constitute object data searchable using the real-time query processing system.

The object data might be data that is generated in response to a user request; e.g., the object data may not be stored on the network at the time the user request is made. Consider the following example. A user wants to know if widget Z is located in store A (which is part of the RFID system). The user does not care if the widget is at another warehouse or in route on a truck, but only wants to know whether the widget is at the store. The user requests the physical location object data of the widget but limits the search to store A. If the widget did not trigger an event when it arrived at the store (e.g., due to a faulty RFID sensor), the real-time query system might not find any object data corresponding to the widget. As a result, the user would think the widget was not at the store. However, if the user requests that the real-time query processing system report the current state of the store (e.g., what is visible), another sensor may detect the widget, generate and report event data. The system would then search the event data and notify the user. In this case, the event data was not stored on the network prior to the user request, but was generated as a result of the request. Thus, the real-time query processing system may search real-time data in addition to stored data.

Returning to the example of the pallet of paper towels described above, an example is provided of how object data might be generated and stored on the network. As the pallet of paper towels moves through the supply chain, it may generate events. For example, the pallet may generate an event as it leaves the manufacturing plant, arrives at a distribution center, leaves the distribution center, and arrives at a retail outlet. Each event may trigger an operation such as a generation of a report, notification, billing receipt, etc., as prescribed by the developer. For instance, a notification may require a follow-up action, such as a request for inspection of the pallet when it arrives at the next observation station. These events are triggered across the RFID network, and event information may be located in different domains (e.g., a Tokyo domain or a San Francisco domain)—thus, object data may be located anywhere on the network. It is to be appreciated that the pallet might generate object data that is stored on the network at any point it is tracked across the network, and is not limited to certain observation stations such as the manufacturing, distribution, or retail centers, or to arrival and departure events. The network might include truck integrated GPS sensors to track a shipment as it moves from one location to the next; or humidity or environmental sensors to log the conditions a specific object (or class thereof) was exposed to while moving through the supply chain. Accordingly, an object may generate object data across the network and in different domains, from any number of sources, as it is monitored and tracked by the RFID network.

The real-time query processing system locates object data on the RFID system in a manner similar to an internet search engine. The system may utilize one or more robot programs, or spiders, that crawl data stored on the network to find and identify object data for indexing. The system may include preprocessing modules to prepare (e.g., standardize data, handle sub-data, break data into smaller units) and compress (e.g., delete common or redundant terms, eliminate term stems) the object data to create entries in an index file, such as an inverted index file. Additional steps, such as categorization (e.g., sensor versus object data) or weighting of certain terms or index file entries, may be implemented to increase overall efficiency of the system. When a user makes a user request for a certain type of object data, the system searches the index file and matches entries corresponding to the search string. Relevant object data can then be located and retrieved. If data is generated in response to a user request, the real-time query processing system may automatically update the index file to reflect the generated data. In this way, the real-time processing system keeps track of data in the network, and a user can use the system to rapidly and easily find desired object data.

In one embodiment, the system may include a centralized master index file comprising entries of data found and identified by the spiders. The master index file is an index file of all data found on the network, including location information, from different domains and different levels of the network hierarchy. For example, the master index file may be stored on the network and accessible through, or controlled by, the central computer. When a user requests object data using the web-based GUI, the system searches the master index file, matches entries to a search string, and retrieves object data as required. A master index file may increase the speed of the real-time query processing system by reducing the number of locations the system must look to find object data in response to a user request.

The system may also include a distributed indexing system containing the location information of object data. Each portion of the RFID system, or each level of the network hierarchy, might store a local index file comprising entries of data found and identified by spiders within that portion or level. The local index files may be distributed across the network according to domain. Thus, the Tokyo domain might have one index file relating to the Tokyo domain while the San Francisco domain might have another index file relating to the San Francisco domain. Each domain may have its own spider to find and identify object data. Alternatively, network-wide spiders might be used where the spiders are programmed to report results found within a domain to that domain. When a user inputs a user request for object data, the system searches the index file of each domain in the network, matches entries to the search string, and retrieves object data as required. A user might specify a particular domain if the user is only interested in object data from that domain. For example, a user might specify that the real-time query processing system only search the San Francisco domain. In this case, the system could limit the search the San Francisco index file for object data, and ignore the Tokyo domain index file. Reducing the number of domains to search can increase the speed of the search and/or provide more relevant or accurate search results.

The real-time query processing system might be implemented in a number of different ways. For instance, the system might include spiders that crawl the network at pre-scheduled times, such as during periods of low network activity. The spiders might operate continually. The spiders may also be optimized for different functions. One spider could be optimized to provide deep-level crawling (e.g., searching all data files on the network, even those that do not usually contain object data) while others could be optimized to repeatedly crawl the most frequent sources for object data. Various search methodologies (e.g., breadth-first searching, depth-first searching, other search optimization) may also be implemented. In this manner, the real-time processing system is adaptable to specific applications or networks, and the index file(s) may be kept comprehensive and up to date. The system might be implemented without spiders by reporting all new data in the network to a module which compiles the master index. Domains may be required to report this data at scheduled times (e.g., every day or several times per day) so that the master index may be kept current. The real-time query processing system might also be a combination of these approaches. It is to be realized that one skilled in the art would understand how to implement a search methodology of the real-time query processing system that best satisfies the needs of a specific RFID system.

The real-time query processing system allows a user to request information stored on the network regarding a specific object. A user may identify an object using any type of identifying information, such as by RFID tag, product name, storage or transit location, or date, etc., or any combination of identifying information. A request might be for event logging information such as departure or arrival information from various monitoring stations, or route information, as described above. A user might request the current physical location of an object within the network, the object's state or condition, or registration information, by way of non-limiting example. Thus, a user is not limited to one type of information that can be requested. If the type of object data requested is stored on the network, the user may request that object data using the real-time query processing system.

Furthermore, the real-time query processing system allows a user to request information regarding a class of objects. A user does not need to request information regarding a specific object. For example, a user may request information regarding all widgets in the system that are owned by (or to be delivered to) a certain retailer or customer. In this case, a user can request object data using search criteria such as the type of object (widget) and owner (store A) without specifying a particular object. The real-time query processing system will locate and retrieve all object data regarding the requested class of objects based on the criteria of the user request. The system also allows a user to request object data about the state of the RFID network. The object might be a network object, such as a sensor or other device. Thus, requests might include information generated by a particular sensor or at a particular location (e.g., all reports from sensor X or warehouse A), or about a state or condition of the system (e.g., type or number of humidity sensors deployed in warehouse A). The level of detail or specificity of the request is definable by the user. A request might be for a certain type of data (e.g., failure reports), or for a certain type of data tied to a location (generated by warehouse A) on a particular date. The real-time query processing system is a comprehensive search system that allows for a range of search criteria, depending upon the requirements of a particular user or a particular search request. In this way, the real-time query processing system offers flexible and robust search capability throughout the network.

The real-time query processing system handles a user request in a manner similar to an internet search engine. The system may be a keyword-based or a full natural language processing system. A user can initiate a user request by inputting a search string into the web-based GUI specifying the search criteria. For example, a search string might be a text search string and include natural language, Boolean operators or other operators, or a combination of natural language and operators. Alternatively, the text search string might be based on SQL query, or other query methodology known in the art. Using the search string, the system may tokenize query terms, recognize special operators, and perform a search using the query terms. A more sophisticated system might include additional steps, such as deleting terms (e.g., common or redundant terms), create a query representation; expand or narrow the query (e.g., including similar terms or expanding root terms), and weight the query for relevance ranking. Those of ordinary skill in the art will recognize that the sophistication of the query processing can be varied depending upon the requirements of a particular network or supply chain.

In addition, the real-time query processing system is accessible through the world wide web using the web-based GUI, so that a user may make a search request from off-site or out-of-network locations. The network may include a web server connected to a central computer that allows a remote user to connect to the network. The central computer may include computer instructions or software pertaining to the real-time query processing system. For example, the user interface 22 described previously may include a separate Query pane, or an Inventory Search pane might include a query function implementing the system. The real-time query system may also be a separate graphical user interface that is separate from user interface 22, and function as a stand-alone query program. Different versions of the system may be used if different functionality is preferred for a specific application. Thus, one version of the real-time query processing system might provide unrestricted search capabilities for user within the network. A different, restricted version, might be made remotely available over the web. By way of example, a restricted version might be made available to customers for querying the network for the location of customer-purchased goods (e.g., whether the object is located at a store or in transit), but only by customer number or other specific search criteria. The system may also be implemented with configurable levels of security, such as to provide other applications with varying levels of search functionality. Thus, the real-time query processing system is robustly adaptable, enabling flexible supply chain management, maintenance, and observation from off-site or off-network locations.

When a user requests object data using the web-based GUI, the system searches the index file, matches entries to the search string, and retrieves object data as required. The object data may be displayed in the web-based GUI, such as in a portion of the Query pane or Inventory Search pane, or may be displayed in a separate Results pane. Multiple search results may be displayed as a list of relevant object data corresponding to the user request. A user might then click on individual object data to display the full data associated with a particular entry in the list. The entry may be an expandable entry, or might be a linkable entry where the full data is displayed in a separate window or pane. For example, in response to a user request the real-time query processing system might initially display multiple object data entries based on the index file, a user may then select relevant object data, whereupon the system retrieves the user-selected object data, and displays the data to the user. In this manner, the system can decrease the response time to user-requests (e.g., generating search results) by only retrieving data that a user finds relevant based on the search results.

The real-time processing system may also automatically retrieve all object data that is identified in the index file in response to a user request (e.g., the system may cache the object data). The full data associated with a particular entry in the search results may be displayed when the user selects that entry. In this way, the system can decrease the response time to user selections (e.g., retrieving search results) since the user will not need to wait for the system to retrieve data each time the user selects a particular search result entry.

The real-time query processing system may also include more sophisticated matching methodologies to rank multiple search results according to relevance. For example, the real-time query processing system might weight query terms in the search string to better match a user-request to entries stored in the index file. Entries in the index file may likewise be weighted for relevance ranking of search results; for instance, certain file types or sources of object data may be weighted more heavily because they tend to contain object data that is frequently requested using the real-time query processing system. Other file types or sources of object data may be discounted if they do not typically contain object data that is useful to a user. The particular weighting methodology employed by the system can be adapted to the requirements of a particular RFID system. A scoring algorithm may also be implemented to further refine and rank the search results. For example, a similarity score might be calculated to rank a search result based on certain conditions (e.g., number of query terms present, the distribution of query terms, td/idf ranking, Boolean logic conditions, date, query term weighting). A more sophisticated real-time query processing system may also include some form of feedback (e.g., prior user selections, search history, file types, etc.) to optimize ranking of documents. It is to be realized that one skilled in the art would understand how to implement a ranking methodology that best satisfies the needs of a specific RFID system. Now, examples of the user interface for a particular web-based implementation of the real-time query processing system in the RFID system shown in FIG. 1 above are described in more detail.

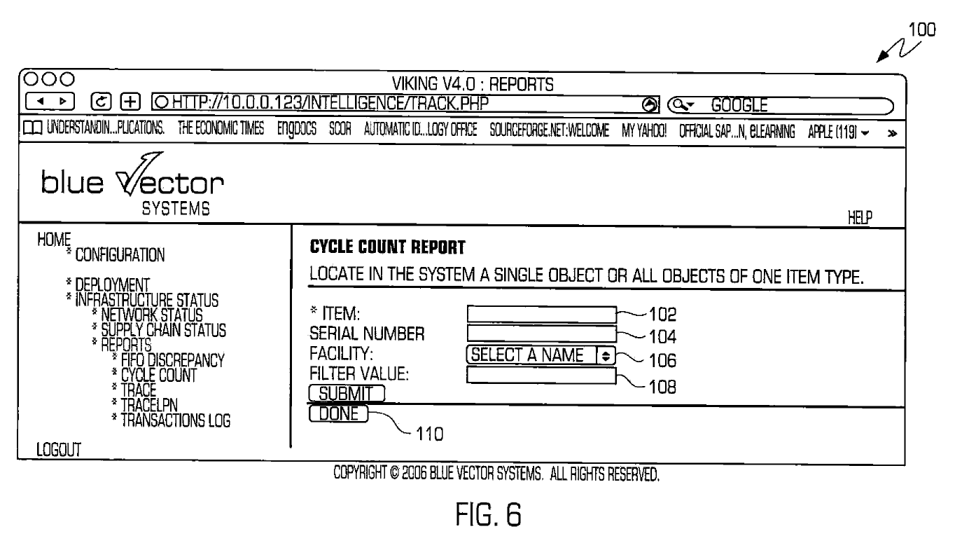

FIG. 6 illustrates a user interface 100 which is a web page in this example from which a user of the real-time query processing system is able to request a search for an item or a group of items with a particular item type. In this example, the real-time query is known as a cycle count. The user interface may include a field 102 in which a user can enter an item identification or description to search for a particular object or objects of a particular item type, a field 104 that permits the user to enter a serial number on which to perform an object search for a particular object, a field 106 that permits the user to limit the search to a particular facility or set of facilities (such as a particular store or distribution facility) and a field 108 that permits the user to enter a filter value to limit the scope of the search. Once the user has entered a real-time query into the user interface, the user may click on a submit button 110 to have the search performed by the real-time query processing system.

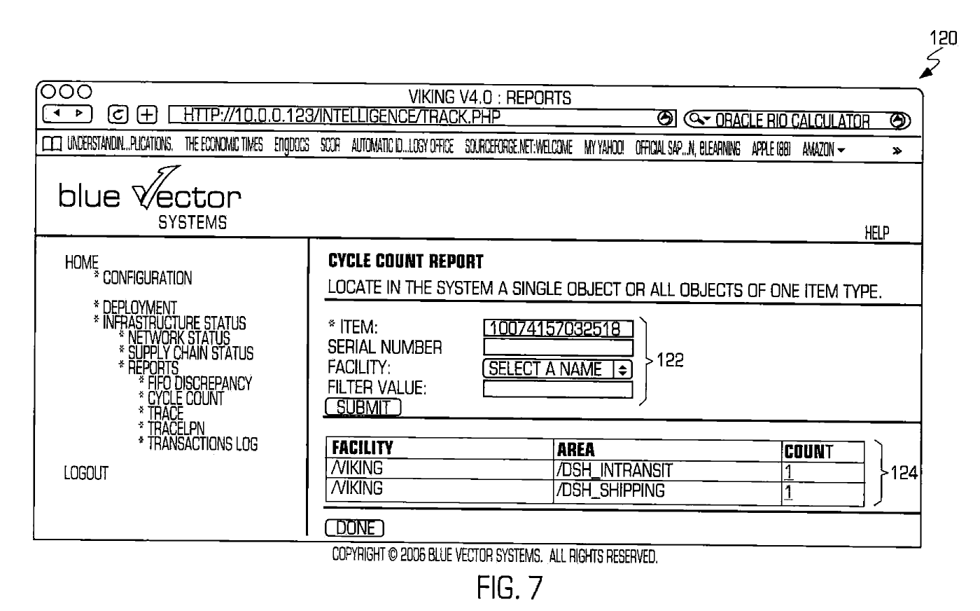

FIG. 7 illustrates a user interface 120 which is a web page in this example that displays the results of the search entered into the user interface shown in FIG. 6. In the example shown in FIG. 7, a particular item having an identifier has been found wherein the specifics of the object are shown in the object identification portion 122 of the user interface. The results user interface also may include an area/facility portion 124 that displays the one or more facilities in which the item is located along with the one or more areas within each facility in which the item is located. In this example, there are two instances of the item (Count =1 for each occurrence) that are located in the same facility (/Viking), but in different areas (/DSH_Intransit and /DSH_Shipping) in the facility. The user interface also displays the number of items (known as counts) at each areas of each facility. The user may then click on the count indication in this user interface to drill down into the information about the particular one or more items at a particular area of the particular facility.

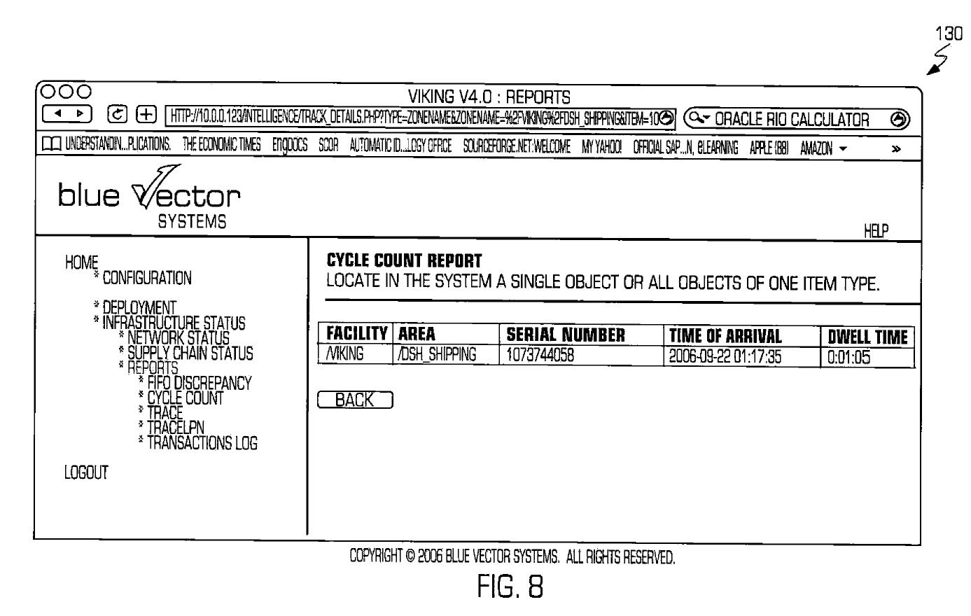

FIG. 8 illustrates a user interface 130 which is a web page in this example that displays the more detailed information about one or more items at a particular area of the particular facility. This user interface shows the specifics for the item, such as the facility in which the item is located, the area in which the item is located, the serial number of the particular item, the time of arrival of the particular item and the dwell time of the particular item. Thus, the user can use the real-time query processing system to search or and locate an item or a group of items within the organization that uses, in this example, the RFID system in FIG. 1.

While the foregoing has been with reference to a particular embodiment of the invention, it will be appreciated by those skilled in the art that changes in this embodiment may be made without departing from the principles and spirit of the invention.

What is claimed is:

1. A system for searching for information about an object associated with a network, the system comprising:
at least one radio frequency identification sensor that detects objects and generates a piece of object data about one or more objects within a domain;
a storage unit that stores the pieces of object data, the storage unit also having an index file that stores a location of the object data in the domain; and
a query processing unit having a crawling unit that searches the domain for object data and stores the locations of objects associated with the object data in the index file and a retrieval unit that receives a query for object data having one or more query terms and retrieves the object data based on the index file.

2. The system of claim 1 wherein the retrieval unit further comprises a matching unit that matches the one or more query terms to the index file and ranks the matches based on relevance.

3. The system of claim 2 wherein the query processing unit further comprises a display unit that displays the ranked matches to a user as one or more selectable entries, wherein the user selects a selectable entry and the retrieval function retrieves the query object data corresponding to the selected entry.

4. The system of claim 2 further comprising a secondary domain of the network that is in communication with the domain, wherein the crawling unit searches the secondary domain for object data and stores the locations of object data in the index file.

5. The system of claim 4, wherein the retrieval unit retrieves object data for objects in the secondary domain based on the locations of object data stored in the index file.

6. The system of claim 1 further comprising:
at least one radio frequency identification sensor that detects objects and generates a piece of object data about one or more objects within a secondary domain that is communication with the domain;
a secondary storage unit that has a secondary index file that includes locations of object data located in the secondary domain; and
wherein the crawling unit searches the secondary domain for object data and stores the locations of object data in the secondary index file.

7. The system of claim 6 further comprising a matching unit that matches the one or more query terms against the locations of object data in the index file and against the locations of object data in the secondary index file.

8. The system of claim 7, wherein the retrieval unit also retrieves the object data from the secondary domain based on the secondary index file.

9. A system for searching for information in a network comprising:
a network management computer that stores object data including object data generated by one or more RFID sensors in a network wherein the object data includes location information about the object; and
a query processing unit having a retrieval unit that receives an object query having one or more query terms and searches the network management computer for object data and retrieves the object data based on the one or more query terms.

10. The system of claim 9, wherein the query processing unit is part of the network management computer.

11. The system of claim 9 wherein the query processing unit is located on a computer connected to the network through a communications link.

12. The system of claim 9, wherein the query processing unit further comprises a crawling unit that searches the network management computer and stores the locations of objects associated with the object data in an index file and wherein the retrieval unit retrieves the object data based on the index file.

13. The system of claim 9 further comprising:
one or more layers of secondary network management computers in communication with the primary network management computer, wherein the one or more layers of secondary network management computers stores object data; and
wherein in response to the query, the query processing unit searches the one or more layers of secondary network management computers for object data that is query object data related to the query object and retrieves the query object data.

14. The system of claim 13, wherein the query processing unit further comprising a crawling unit that searches the network management computer and the secondary network management computers for object data and stores the locations of object data in at least one index file; and wherein, in response to a query, the query processing unit searches the one or more layers of secondary network management computers and the network management computer for object data that is query object data related to the query object based on the at least one index file.

15. A method of searching for information in a network, comprising:
storing object data in the network, including object data generated by at least one RFID sensor and a location of the object data in an index file;
receiving a query for object data, the query having one or more query terms;
searching, in response to the query, the index file for locations of object data that is relevant to the one or more query terms; and
retrieving the query object data based on the locations of object data stored in the index file.

16. The method of claim 15 further comprising matching the one or more query terms to the locations of object data stored in the index file to generate a set of matches and ranking the set of matches based on relevance to generate a set of ranked matches.

17. The method of claim 16 further comprising displaying the set of ranked matches to a user as one or more selectable entries, permitting the user to select a selectable entry, and retrieving the query object data corresponding to the selected entry.

18. The system of claim 17 further comprising generating object data in response to the user request, storing the generated object data in the network, and storing the locations of generated object data in the index file.
